(19) United States
(12) Patent Application Publication
(10) Pub. No.: US 2009/0130410 A1
(43) Pub. Date: May 21, 2009

(54) STAINLESS STEEL SHEET COATED WITH A SELF-CLEANING COATING

(75) Inventors: Jean-Michel Damasse, Bethune (FR); Jacques Charles, Le Breuil (FR); Michel Langlet, Le Versoud (FR); Siriwan Permpoon, Nonthaburi (TH); Jean-Charles Joud, Meylan (FR); Bernard Baroux, Saint-Jorioz (FR)

Correspondence Address: OBLON, SPIVAK, MCCLELLAND MAIER & NEUSTADT, P.C., 1940 DUKE STREET, ALEXANDRIA, VA, 22314, US

(73) Assignee: UGINE & ALZ FRANCE, Saint-Denis (FR)

(21) Appl. No.: 12/293,179

(22) PCT Filed: Jan. 15, 2007
(86) PCT No.: PCT/FR2007/000070

§ 371 Date: Dec. 10, 2008

(30) Foreign Application Priority Data
Mar. 2, 2006 (EP) 06290367.9

(51) Int. Cl. B32B 15/04; B05D 1/36

(52) U.S. Cl. 428/216; 428/315.7; 427/419.3

(57) ABSTRACT

The invention has as an object a stainless steel sheet coated with a coating comprising, in the order starting from the surface of the said sheet:
a barrier layer of metallic oxide or oxy-hydroxide MOₓ, or of metallic nitride or oxy-nitride NMₓ, having a thickness ranging between 5 and 1000 nm,
a porous layer of titanium oxide TiOₓ having a thickness ranging between 5 and 1000 nm, the said TiOₓ layer having a voluminal porosity ranging between 10 and 50% and a mean pore size ranging between 0.5 and 100 nm and
an upper layer of silicon oxide or oxy-hydroxide SiOₓ having a thickness ranging between 5 and 1000 nm.

The invention also relates to the method for manufacture of this coated sheet.

This invention relates to a stainless steel sheet coated on at least one of its faces with a self-cleaning coating, and the method for manufacture of such a coated sheet.

For reasons of both cleanliness and hygiene, it is essential to prevent soiling and to reduce the adherence of microorganisms on the surfaces, for example, of buildings and equipment in the food-processing industry or in the pharmaceutical industry. Stainless steel generally is used for this type of application, because this material has a good resistance to corrosion and can be cleaned easily, for example with water with detergent added.

In order to reduce the maintenance of such surfaces, and to avoid the use of detergent harmful to the environment, it is known to coat them with a coating of titanium dioxide TiO₂, preferably in its anatase crystalline form. In fact, when it is subjected to UV radiation (radiation having a wavelength less than 380 nm), for example during exposure to the light from a fluorescent source or to sunlight, the titanium dioxide has an activity at once photo-catalytic and super-hydrophilic. The photo-catalytic activity makes possible the partial or total degradation of the organic compounds present on the surface. The photo-induced super-hydrophilic activity ensures the self-cleaning capability of the surface, insofar as it allows washing away of the residual organic compounds by mere rinsing with water without addition of detergents, or by the rain. In the absence of UV radiation, however, the surfaces treated with this type of coating rapidly lose their photo-catalytic and super-hydrophilic activity.

Titanium dioxide doped with nitrogen, obtained through incorporation of a small quantity of nitrogen in the titanium dioxide in its anatase form, has a photo-catalytic and super-hydrophilic activity when it is exposed to a visible luminous radiation (wavelength ranging between 400 and 700 nm). In the absence of visible light, however, the surfaces coated with titanium dioxide doped with nitrogen also rapidly lose their photo-catalytic and super-hydrophilic activity.

The coatings of the prior art therefore have the drawback of losing their self-cleaning nature in the absence of exposure to a UV radiation or to a visible luminous radiation, as the case may be, which can be restored only after another exposure either to a UV radiation or to a visible luminous radiation.

It just so happens that most of the equipment used in the food-processing industry, such as, for example, collective cooking installations, domestic appliances and electrical household appliances often are used or stored in rooms devoid of UV light, or even of visible light, and the coatings cited previously are ineffective for reducing or facilitating the maintenance thereof.

The purpose of this invention is to remedy the drawbacks of the prior-art coatings and to make available a stainless steel sheet coated with a coating having a super-hydrophily lasting for at least three weeks, without its being necessary to subject it to an exposure to UV radiation or to visible luminous radiation in order to restore the super-hydrophily of the coating.

The super-hydrophily of a surface is quantified by the evaluation of the angle of contact of pure water at the surface. Stainless steel has an angle of contact of pure water on the order of 600. Thus, if water is poured over stainless steel, droplets of water form. On a surface having a superior hydrophily, the droplets of water flatten out. This is what is seen on certain types of glass having an angle of contact of pure water on the order of 30°. In the sense of this invention, there is understood by super-hydrophilic surface a surface having an angle of contact of water equal to 0°, which allows the water to form a uniform film of water on the surface.

The invention therefore has as an object a stainless steel sheet coated on at least one of its faces with a coating comprising, in the order starting from the surface of the said sheet:
a barrier layer of metallic oxide or oxy-hydroxide MOₓ, or of metallic nitride or oxy-nitride NMₓ, having a thickness ranging between 5 and 1000 nm, and preferably between 20 and 850 nm,
a porous layer of titanium oxide TiOₓ having a thickness ranging between 5 and 1000 nm, preferably ranging between 20 and 500 nm, and advantageously ranging between 30 and 200 nm, the said TiOₓ layer having a voluminal porosity ranging between 10 and 50% and a mean pore size ranging between 0.5 and 100 nm,
an upper layer of silicon oxide or oxy-hydroxide SiOₓ having a thickness ranging between 5 and 1000 nm, and preferably ranging between 20 and 850 nm.

The coating according to the invention increases the wetting capability of the water without its being necessary to expose it to UV radiation or visible luminous radiation. Because of the super-hydrophilic nature of the said coating, the water is distributed uniformly over the surface of the treated stainless steel, and forms a uniform film of water. Moreover, if the surface is vertical or oblique, the film of water eliminates a portion of the impurities that are deposited on the surface, by flowing along the surface.

Finally, when the surface dries, the traces of water that usually are found on untreated surfaces are avoided, still because of the super-hydrophilic nature of the coating.

The sheet according to the invention also may comprise the following characteristics:
the said porous layer of titanium oxide TiOₓ is a layer of titanium dioxide TiO₂,
the titanium dioxide TiO₂ is in its anatase crystalline form,
the said porous layer of TiOₓ has a voluminal porosity ranging between 20 and 40%, and a mean pore size ranging between 1 and 20 nm,
the said upper layer of silicon oxide is dense,
the said upper layer of silicon oxide is a layer of silicon dioxide SiO₂,
the said barrier layer of metallic oxide or oxy-hydroxide MOₓ is chosen from among the oxides or oxy-hydroxides of silicon, tin, aluminum, alone or in combination,
the said barrier layer of metallic nitride or oxy-nitride is of silicon nitride or oxy-nitride,
the said barrier layer is chosen from among SiO₂, SnO₂, Al₂O₃, alone or in combination.

The invention also has as an object a method for manufacture of this coated stainless steel sheet, comprising the successive steps consisting in:
depositing a barrier layer of metallic oxide or oxy-hydroxide MOₓ, or of metallic nitride or oxy-nitride NMₓ, on at least one of the faces of the said stainless steel sheet,
depositing, by a sol-gel deposition method, a porous layer of titanium oxide TiOₓ on the surface of the said barrier layer coating the sheet, and
depositing a layer of silicon oxide or oxy-hydroxide SiOₓ on the said layer of titanium oxide TiOₓ.

The method according to the invention also may comprise the following characteristics:
the said porous layer of TiOₓ is formed by application on the said barrier layer of a polymeric sol comprising 0.1 to 0.6 mole/l of an organometallic precursor of titanium, the said organometallic precursor of titanium possibly being a titanium alkoxide Ti(OR)₄ in which R is an alkyl chain containing 1 to 4 carbon atoms,
the said porous layer of TiOₓ is formed by application on the said barrier layer of a crystalline suspension comprising 0.1 to 0.4 mole/l of nano-crystallites of titanium dioxide dispersed in a dispersive solvent,
the said barrier layer and/or the said upper layer of SiOₓ is deposited by a sol-gel method,
the said barrier layer is formed by application, on at least one of the faces of the said stainless steel sheet, of a polymeric sol comprising 0.2 to 2 mole/l of at least one precursor chosen from among an organometallic compound and a metallic salt, the said organometallic compound possibly being a metallic alkoxide M(OR)₃ or M(OR)₄ in which M is silicon, aluminum or tin, and R is an alkyl chain containing 1 to 4 carbon atoms, and the said metallic salt possibly is a nitrate or a chloride of silicon, aluminum or tin,
the said upper layer of SiOₓ is formed by application on the said TiOₓ layer of a polymeric sol comprising 0.2 to 2 mole/l of an organometallic precursor of silicon, the said organometallic precursor of silicon possibly being a silicon alkoxide Si(OR)₄, in which R is an alkyl chain containing 1 to 4 carbon atoms.

The invention also has as an object an installation for the food-processing industry or a prefabricated section for a building made from this coated stainless steel sheet. It likewise has as an object the use of this coated stainless steel sheet in order to remove the dirt adhering to the coating by washing with water or with rainwater, without its being necessary to add a detergent to the water, and without its being necessary to subject the said sheet to a UV radiation or to a visible luminous radiation.

Finally, the intervention has as an object the intermediate product that can be obtained, that is, a stainless steel sheet coated on at least one of its faces, with a coating comprising, in the order starting from the surface of the said sheet:
a barrier layer of metallic oxide or oxy-hydroxide MOₓ, or of metallic nitride or oxy-nitride NMₓ, having a thickness ranging between 5 and 1000 nm, and preferably ranging between 20 and 850 nm.
a porous layer of titanium oxide TiOₓ having a thickness ranging between 5 and 1000 nm, preferably ranging between 20 and 500 nm, and advantageously ranging between 30 and 200 nm, the said layer of TiOₓ having an RMS roughness ranging between 0.5 and 50 nm, and preferably ranging between 1 and 20 nm, a voluminal porosity ranging between 10 and 50% and a mean pore size ranging between 0.5 and 100 nm.

The characteristics and advantages of the invention will become more apparent in the course of the description that will follow, given by way of non-limitative example.

The stainless steel sheet according to the invention is coated with a coating having a natural super-hydrophily lasting over time, even if it is kept in darkness for more than three weeks, without its being necessary to subject it to a UV or visible luminous radiation in order to activate the super-hydrophily or to restore it. For this purpose, the sheet is coated on at least one of its faces with a coating comprising, in the order starting from the surface of the steel, a barrier layer having a thickness in excess of 5 nm, a porous TiOₓ oxide layer having a thickness ranging between 5 and 1000 nm and an upper layer of silicon oxide or oxy-hydroxide SiOₓ having a thickness in excess of 5 nm.

The inventors demonstrated that in order to impart to the sheet a super-hydrophilic nature lasting over time, the porous layer of TiOₓ should have a voluminal porosity ranging between 10 and 50% and a mean pore size ranging between 0.5 and 100 nm. Preferably, the voluminal porosity of the TiOₓ layer ranges between 20 and 40% and the mean pore size ranges between 1 and 20 nm.

The voluminal porosity is estimated from the index of refraction of the TiOₓ layer using the following Lorentz-Lorenz formula:

1−P/100=(n²−1)/(N²−1)×(N²+2)/(n²+2),
in which:
n is the index of refraction of the TiOₓ layer,
P is the voluminal porosity of the TiOₓ layer, and
N is the index of refraction of the dense titanium oxide, that is, the nonporous titanium (for example N is equal to 2.5 for the TiO₂ crystallized in its anatase form)

The index of refraction is measured at the wavelength of 632 nm by means of a Sentech ellipsometer.

The pore size is estimated by a surface imaging using a scanning electron microscope with ZEISS Ultra 55 field effect.

Not wishing to be bound by any theory, the inventors believe that the enhanced super-hydrophilic properties obtained according to the invention are based on the combined SiOₓ—TiOₓ planar interface effects between the upper SiOₓ layer and the lower TiOₓ layer. As it happens, prior to deposition of the upper SiOₓ layer, the TiOₓ layer has an RMS roughness ranging between 0.5 and 50 nm, and preferably between 1 and 20 nm. Thus, by increasing the RMS roughness and the porosity of the TiOₓ layer, the contact surface at the interface is increased, and the planar interface effects can be enhanced. The inventors established, however, that for an RMS roughness in excess of 50 nm, a voluminal porosity in excess of 50%, and a pore size in excess of 100 nm, the optical quality and the mechanical resistance of the TiOₓ layer decrease markedly. A high optical quality of the TiOₓ layer means that the said layer does not lead to any optical loss through diffusion of the light, which makes it possible to preserve the surface appearance of the steel and, for example, to preserve the shiny appearance of a steel sheet that might have been polished beforehand. According to the invention, the mechanical resistance of the said TiOₓ layer preferably is at least equal to that of the steel sheet; that makes it possible, in particular, to obtain a coating resistant to scratches and impacts. When the RMS roughness is less than 5 nm, the voluminal porosity less than 10% and the mean pore size less than 0.5 nm, the inventors did not observe any significant long-term lasting quality of the super-hydrophily.

The RMS roughness corresponds to a mean quadratic roughness defined as being the quadratic mean of the variations in the roughness profile in relation to a mean line within a base length. The RMS roughness is measured by means of a Digital Atomic Power Multimode Nanoscope Instrument.

The titanium oxide TiOₓ may be titanium dioxide, and may be in its amorphous form, or its rutile or anatase crystalline form, or a combination of these forms. The best results in terms of super-hydrophily, however, were obtained when the titanium dioxide was in its anatase crystalline form. The layer of titanium oxide TiOₓ is deposited on the barrier layer, preferably by a sol-gel deposition method. The sol-gel deposition method has the advantage of making it possible to form, in a single deposition step, a TiOₓ layer having a uniform thickness ranging between 20 and 200 nm, and not having any cracks. It also has the advantage of making it possible to control the porosity of the TiOₓ layer as well as the mean size of the pores. In addition, this deposition method makes it possible to produce coatings having a high homogeneity and a high purity.

For this purpose, a liquid solution that may be either a polymeric sol, or advantageously a crystalline suspension, is deposited on the surface of the said barrier layer. In fact, the inventors observed that at equal TiOₓ layer thickness, the use of crystalline suspension made it possible to impart to the sheet a super-hydrophily superior to that obtained with a polymeric sol.

The polymeric sol may comprise 0.1 to 0.6 mole/l of an organometallic precursor of titanium and a solvent. The organometallic precursor of titanium may be a titanium alkoxide Ti(OR)₄ in which R is an alkyl chain containing 1 to 4 carbon atoms. The organometallic precursor of titanium preferably is titanium isopropoxide.

The crystalline suspension may comprise 0.1 to 0.4 mole/l of nano-crystallites of titanium dioxide dispersed in a dispersive solvent such as, for example, water or an alcohol. The crystallites of titanium dioxide preferably are in the anatase crystalline form.

The deposition of the polymeric sol or of the crystalline suspension is performed by a liquid-phase coating technique, for example by dipping, by spraying or by centrifugal application. In order to accelerate the crystallization of the TiOₓ layer into its anatase or rutile crystalline form, in the case of a polymeric sol, or to evaporate the solvent more rapidly in the case of a crystalline suspension, the TiOₓ layer furthermore may be subjected to a thermal treatment by bringing the sheet to a temperature ranging between 100 and 600° C., and maintaining it at this temperature for a period ranging between 5 and 120 minutes.

The thickness of the SiOₓ upper layer is not particularly limited; the inventors, however, noted that beyond 1000 nm, the super-hydrophilic nature of the coating is not improved.

Insofar as the upper layer of the coating is likely to be subjected to friction, it is advantageous that the SiOₓ upper layer be dense, that is, that it have a voluminal porosity close to 0%, which imparts a markedly improved abrasion resistance to the coating. In fact, the more porous the SiOₓ layer, the weaker its mechanical resistance and the more sensitive it is to scratches.

The upper layer of silicon oxide SiOₓ preferably is a layer of silicon dioxide SiO₂.

After having formed the TiOₓ layer on the barrier layer, the upper layer of silicon oxide or oxy-hydroxide SiOₓ preferably is deposited by a sol-gel method. This sol-gel method of deposition has the advantage of making it possible to form, in a single deposition step, an SiOₓ layer having a uniform thickness ranging between 20 and 850 nm, and not having any cracks. For this purpose, a liquid solution consisting of a polymeric sol comprising 0.2 to 2 mole/l of a precursor and a solvent is deposited on the surface of the said TiOₓ layer.

The precursor may be an organometallic compound of silicon, or even a silicon salt. It reacts by hydrolysis and by polycondensation to form SiOₓ.

The organometallic compound of silicon may be a silicon alkoxide Si(OR)₄ in which R is an alkyl chain containing 1 to 4 carbon atoms. The preferred precursor is tetraethoxy orthosilicate.

The silicon salt may be, for example, a nitrate or a chloride of silicon.

The deposition of the liquid solution is performed by a liquid-phase coating technique, for example by dipping, by spraying or by centrifugal application of the solution.

The sol-gel deposition method by the polymeric process furthermore has the advantage of forming a dense SiOₓ layer, that is, an SiOₓ layer the voluminal porosity of which is close to 0%, having an excellent mechanical resistance.

In order to accelerate the densification of the layer and to evaporate the solvent more rapidly, the SiOₓ layer furthermore can be subjected to a thermal treatment by bringing the sheet to a temperature ranging between 300 and 600° C., and maintaining it at this temperature for a period ranging between 5 and 120 minutes.

The barrier layer included between the steel sheet and the layer of titanium oxide TiOₓ makes it possible to avoid diffusion of the metallic elements of the steel into the TiOₓ layer. In fact, the inventors became aware that, in the absence of this barrier layer, the metallic elements of the steel, such as iron, for example, contaminate the titanium oxide layer and that the effectiveness of the coating in terms of super-hydrophily thereby are rapidly reduced over the course of time. The inventors also noted that, apart from its role as a diffusion barrier, this layer also contributes to an enhanced super-hydrophily by creating an additional planar interface with the titanium oxide layer.

The barrier layer has a thickness ranging between 5 and 1000 nm. In fact, the inventors noted that below 5 nm, the barrier effect is insufficient and the metallic elements of the steel migrate into the upper TiOₓ layer, which damages the super-hydrophily of the coating. Beyond 1000 nm, the effectiveness of the barrier layer is not improved.

The barrier layer may be made up of at least one layer of metallic oxide or oxy-hydroxide MOₓ, preferably chosen from among the oxides of silicon, tin, aluminum, alone or in combination, and advantageously chosen from among SiO₂, SnO₂, Al₂O₃, alone or in combination. It advantageously is made up of a layer of silicon oxide SiO₂. The barrier layer also may be made up of at least one layer of metallic nitride or oxy-nitride NMₓ, such as, for example, a layer of silicon nitride or oxy-nitride.

The barrier layer of metallic oxide or oxy-hydroxide MOₓ preferably is deposited, on at least one of the faces of the sheet, by a sol-gel deposition method, after having subjected a stainless steel sheet to a thermal treatment of the bright-annealing or pickled-hardening type, depending on whether one is trying to obtain a bright surface or, on the contrary, a matte surface. The sol-gel deposition method is preferred to the other deposition methods because it makes it possible to form, in a single deposition step, an MOₓ layer having a uniform thickness ranging between 20 and 850 nm and not having any cracks. In addition, this deposition method makes it possible to produce coatings having a high homogeneity and a high purity. For this purpose, a liquid solution consisting of a polymeric sol comprising 0.2 to 2 mole/l of at least one precursor and a solvent is deposited on at least one of the faces of the sheet by a liquid-phase coating technique, for example by dipping, by spraying or by centrifugal application of the solution.

The precursor may be an organometallic compound, or even a metal nitrate or chloride. It reacts by hydrolysis and by polycondensation to form MOₓ.

The organometallic precursor may be a metal alkoxide M(OR)₃ or M(OR)₄, in which M is chosen from among silicon, tin and aluminum, and R is an alkyl chain containing 1 to 4 carbon atoms. The preferred organometallic precursor is tetraethoxy orthosilicate.

The precursor consisting of a metal nitrate or chloride may be a silicon nitrate or a silicon chloride.

In order to accelerate the densification of the layer and to evaporate the solvent more rapidly, the barrier layer furthermore may be subjected to a thermal treatment by bringing the sheet to a temperature ranging between 300 and 600° C., and maintaining it at this temperature for a period ranging between 5 and 120 minutes.

The barrier layer of metallic nitride or oxy-nitride NMₓ may be deposited by any conventional method making it possible to obtain a thin coating layer.

The invention now is going to be illustrated by examples presented by way of indication, not limitation.

For that, a first batch of samples (samples A) cut out in a sheet made of grade 304 2R stainless steel were coated with a layer of SiO₂ by a centrifugal application method using a polymeric sol comprising 1.5 mole/l of tetraethoxy orthosilicate, absolute ethanol, 3/3 mole/l of deionized water and hydrochloric acid to adjust the pH of the polymeric sol to 3.5. The coated samples then were brought to 500° C., and maintained at this temperature for 120 minutes, in order to form a layer of silicon dioxide SiO₂ with thickness 190 nm.

A second batch of samples (samples B and D) cut out in the same sheet made of grade 304 2R stainless steel which previously were coated with a two-layer coating comprising a first layer of TiO₂ in contact with the surface of the steel, and an upper layer of SiO₂.

A third batch of samples (samples C and E) also cut out in the same sheet made of grade 304 2R stainless steel were coated with a three-layer coating according to the invention comprising a first layer of SiO₂ in contact with the surface of the steel, an intermediate layer of TiO₂ and an upper layer of SiO₂.

The thicknesses of the SiO₂ layers are 190 nm for each of the batches B, C, D and E. The SiO₂ layers of the two-layer and three-layer coatings are deposited according to the same procedure as that indicated previously for the first batch of samples, and they are treated thermally at 500° C. for 120 minutes after each layer deposition.

The TiO₂ layer is formed by sol-gel deposition from:
a crystalline suspension comprising 0.24 mole/l of nano-crystallites of TiO₂ in anatase crystalline form dispersed in absolute ethanol (sample B and C), or
a polymeric sol comprising 0.4 mole/l of titanium isopropoxide diluted in absolute ethanol in the presence of 0.32 mole/l of water, and hydrochloric acid to adjust the pH to 1.3 (samples D and E).

In both cases, the TiO₂ layer was treated thermally at 500° C., for 120 minutes, and the characterizations by X-ray diffraction show that they are made up of crystallites of anatase.

The TiO₂ layer obtained by deposition of the crystalline suspension and treated at 500° C. for 120 minutes, has a thickness of 40 nm, an RMS roughness of 5 nm (before deposition of the SiO₂ upper layer), a mean pore size of 15 nm, and a voluminal porosity of 30%.

The TiO₂ layer obtained by deposition of a polymeric sol and treated at 500° C. for 120 minutes, has a thickness of 160 nm, an RMS roughness of 1 nm (before deposition of the SiO₂ upper layer), a mean pore size of 5 nm, and a voluminal porosity of 15%.

In this way, the following samples are obtained:
Sample A: stainless steel sheet coated with a layer of SiO₂.
Sample B: stainless steel sheet coated with a two-layer coating made up of a layer of TiO₂ obtained from a crystalline suspension, and an upper layer of SiO₂.
Sample C: stainless steel sheet coated with a three-layer coating made up of a barrier layer of SiO₂, a layer of TiO₂ obtained from a crystalline suspension, and an upper layer of SiO₂.
Sample D: stainless steel sheet coated with a two-layer coating made up of a layer of TiO₂ obtained from a polymeric sol, and an upper layer of SiO₂.
Sample E: stainless steel sheet coated with a three-layer coating made up of a barrier layer of SiO₂, a layer of TiO₂ obtained from a polymeric sol, and an upper layer of SiO₂.

After having formed the one-, two- or three-layer coatings, the samples are allowed to age by keeping them in darkness, that is, in the absence of any luminous radiation for 84 days. Their super-hydrophily is evaluated regularly, by measuring the angle of contact that drops of pure water form on the coating, by means of a video camera connected to a KRUSS G 10 goniometer. The results of the measurements are consolidated in Table I.

TABLE I

| | Angle of contact of water (°) measured according to | | | | | | | |
|---|---|---|---|---|---|---|---|---|
| | the ageing of the sample (number of days in darkness) | | | | | | | |
| | 0 | 7 | 14 | 21 | 28 | 56 | 70 | 84 |
| | day | days | days | days | days | days | days | days |
| Sample A | 2° | 0° | 3° | 5° | 5.5° | n.m. | n.m. | n.m. |
| Sample B | 0° | 0° | 4° | 5.5° | 6.5° | n.m. | n.m. | 14° |
| *Sample C | 0° | 0° | 0° | 0° | 0° | 0° | 0° | 4.5° |
| Sample D | 0° | 0° | 3.5 | 5 | 5.5 | n.m. | n.m. | n.m. |
| *Sample E | 0° | 0° | 0° | 0° | 0° | 18.5° | n.m. | n.m. |

*according to the invention
n.m. = not measured

The results of Table I clearly show that the stainless steel sheets coated with three-layer coatings according to the invention have a natural and long-lasting super-hydrophily which single SiO₂ coatings deposited on stainless steel sheets do not possess. Not wishing to be bound by any theory, the inventors believe that this effect is linked to the presence of SiO₂—TiO₂-type planar interfaces.

The longer lasting quality of super-hydrophily of a stainless steel sheet coated with a three-layer coating from a crystalline suspension of TiO₂ shows the influence of the method of production of the coatings which makes it possible to verify a porosity and a roughness appropriate to the SiO₂—TiO₂ interface and in this way to increase the surface specific to this interface.

Irrespective of the method of production, the shorter lasting quality of super hydrophily of the stainless steel sheet coated with two-layer coatings is attributed to the contamination of the TiO₂ by elements deriving from the steel at the time of liquid-phase deposition of TiO₂ and/or at the time of thermal treatment. The two-layer coatings formed in this way do not have enhanced hydrophilic properties in comparison with a single layer of SiO₂ deposited on a stainless steel sheet. The contamination of the TiO₂ layer in a two-layer coating by elements originating from the steel has no positive influence on the super-hydrophilic properties.

Furthermore, the inventors noted that natural super-hydrophily without UV radiation and without exposure to visible light disappears at the end of a certain period of ageing. The super hydrophily of the two-layer coating obtained from a crystalline suspension according to the invention is markedly reduced at the end of 14 days, and the angle of contact of water measured at the surface of this coating after 84 days of ageing is 14°. The super-hydrophily is far less reduced at the end of 84 days for the tree-layer coating obtained from a crystalline suspension according to the invention and the angle of contact measured after this ageing is 4.5°.

The reduction of the super-hydrophily is attributed to the contamination of the outer SiO₂ layer by carbonaceous species deriving from the ambient atmosphere. The inventors became aware that the super-hydrophily of the three-layer coatings according to the invention could be restored easily by spraying of the coating, for at least one minute, with water at a temperature ranging between 20 and 30° C., without UV radiation and without exposure to visible light.

After 84 days of maintenance in darkness, samples B and C thus were sprayed with a flow of water at 25° C., for 1 min, then were dried with a compressed gas. The angle of contact formed by the drops of pure water deposited on the coating then was measured by means of a video camera connected to a KRUSS G 10 goniometer:
as soon as the samples are dry, and
after a further ageing of the samples by keeping them in darkness for 7 days.

The results are consolidated in Table II

TABLE II

| | | Angle of contact | |
|---|---|---|---|
| | | after spraying | Angle of |
| | Angle of contact | with water | contact after |
| | after ageing for 84 | at 25° C. for 1 min | another ageing |
| | days (°) | (°) | of 7 days (°) |
| Sample B | 14 | 5 | 14 |
| *Sample C | 4.5 | 0 | 0 |

*according to the invention

The difference in behavior of samples B and C clearly shows that a three-layer coating according to the invention cuts down carbonaceous contamination of the stainless steel during a prolonged ageing. That makes it possible to eliminate this slight contamination easily by a mere rinsing with water. In the case of a two-layer coating, the stainless steel sheet becomes contaminated more rapidly, which precludes effective elimination of the carbonaceous contamination under the same operating conditions.

1. Stainless steel sheet coated on at least one of its faces with a coating comprising, in the order starting from the surface of the said sheet:
a barrier layer of metallic oxide or oxy-hydroxide MOₓ, or of metallic nitride or oxy-nitride NMₓ, having a thickness ranging between 5 and 1000 nm,
a porous layer of titanium oxide TiOₓ having a thickness ranging between 5 and 1000 nm, the said TiOₓ layer having an RMS roughness ranging between 0.5 and 50 nm, a voluminal porosity ranging between 10 and 50% and a mean pore size ranging between 0.5 and 100 nm.

2. Sheet according to claim 1, characterized in that the RMS roughness of the said porous layer of TiOₓ ranges between 1 and 20 nm.

3. Stainless steel sheet coated on at least one of its faces with a coating comprising, in the order starting from the surface of the said sheet:
a barrier layer of metallic oxide or oxy-hydroxide MOₓ, or of metallic nitride or oxy-nitride NMₓ, having a thickness ranging between 5 and 1000 nm,
a porous layer of titanium oxide TiOₓ having a thickness ranging between 5 and 1000 nm, the said TiOₓ layer having a voluminal porosity ranging between 10 and 50% and a mean pore size ranging between 0.5 and 100 nm, and
an upper layer of silicon oxide or oxy-hydroxide SiOₓ having a thickness ranging between 5 and 1000 nm.

4. Sheet according to claim 1, characterized in that the thickness of the said porous layer of titanium oxide TiOₓ ranges between 20 and 500 nm.

5. Sheet according to claim 4, characterized in that the thickness of the said porous layer of TiOₓ ranges between 30 and 200 nm.

6. Sheet according to claim 1, characterized in that the voluminal porosity of the said porous layer of TiOₓ ranges between 20 and 40%.

7. Sheet according to claim 1, characterized in that the mean pore size of the said porous layer of TiOₓ ranges between 1 and 20 nm.

8. Sheet according to claim 1, characterized in that the said porous layer of titanium oxide TiOₓ is a layer of titanium dioxide TiO₂.

9. Sheet according to claim 8, characterized in that the titanium dioxide TiO₂ is in its anatase crystalline form.

10. Sheet according to claim 3, characterized in that the thickness of the said upper layer of silicon oxide or oxy-hydroxide SiOₓ ranges between 20 and 850 nm.

11. Sheet according to claim 3, characterized in that the said upper layer of silicon oxide is a layer of silicon dioxide SiO₂.

12. Sheet according to claim 1, characterized in that the thickness of the said barrier layer ranges between 20 and 850 nm.

13. Sheet according to claim 1, characterized in that the said barrier layer of metallic oxide or oxy-hydroxide is chosen from among the oxides or oxy-hydroxides of silicon, tin, aluminum, alone or in combination.

14. Sheet according to claim 13, characterized in that the said barrier layer is chosen from among SiO₂, SnO₂, Al₂O₃, alone or in combination.

15. Sheet according to claim 1, characterized in that the said barrier layer of metallic nitride or oxy-nitride NMₓ is a silicon nitride or oxy-nitride.

16. Method for manufacture of a stainless steel sheet coated according to claim 3, comprising successive steps consisting in:
depositing a barrier layer of metallic oxide or oxy-hydroxide MOₓ or of metallic nitride or oxy-nitride NMₓ on at least one of the faces of the said stainless steel sheet,
depositing, by a sol-gel method, a porous layer of titanium oxide TiOₓ on the surface of the said barrier layer coating the stainless steel sheet, and depositing an upper layer of silicon oxide or oxy-hydroxide SiOₓ on the said layer of titanium oxide TiOₓ.

17. Method according to claim 16, characterized in that the said porous layer of TiOₓ is formed by application on the said barrier layer of a polymeric sol comprising 0.1 to 0.6 mole/l of an organic precursor of titanium.

18. Method according to claim 17, characterized in that the said organic precursor of titanium is a titanium alkoxide Ti(OR)₄, in which R is an alkyl chain containing 1 to 4 carbon atoms.

19. Method according to claim 16, characterized in that the said porous layer of TiOₓ is formed by application on the said barrier layer of a crystalline suspension comprising 0.1 to 0.4 mole/l of nano-crystallites of titanium dioxide dispersed in a dispersive solvent.

20. Method according to claim 16, characterized in that the said barrier layer is deposited by a sol-gel method.

21. Method according to claim 20, characterized in that the said barrier layer of MOₓ is formed by application, to at least one of the faces of the said sheet, of a polymeric sol comprising 0.2 to 2 mole/l of at least one precursor chosen from among an organometallic compound and a metallic salt.

22. Method according to claim 21, characterized in that the said organometallic compound is a metal alkoxide M(OR)₃ or M(OR)₄, in which the metal M is silicon, aluminum or tin, and R is an alkyl chain containing 1 to 4 carbon atoms.

23. Method according to claim 21, characterized in that the said metallic salt is a nitrate or a chloride of silicon, aluminum or tin.

24. Method according to claim 16, characterized in that the said upper layer of silicon oxide or oxy-hydroxide SiOₓ is deposited by a sol-gel method.

25. Method according to claim 24, characterized in that the said upper layer of SiOₓ is formed by application on the said TiOₓ layer of a polymeric sol comprising 0.2 to 2 mole/l of an organometallic precursor of silicon.

26. Method according to claim 25, characterized in that the said organometallic precursor of silicon is a silicon alkoxide Si(OR)₄, in which R is an alkyl chain containing 1 to 4 carbon atoms.

27. Equipment for the food-processing industry made from a stainless steel sheet coated according to claim 3.

28. Prefabricated section for a building made from a stainless steel sheet coated according to claim 3.

29. Use of the stainless steel sheet according to claim 3 in order to remove, through washing with water, the dirt adhering to the said coating without its being necessary to add a detergent to the water, and without its being necessary to subject the said sheet to a UV radiation or to a visible luminous radiation.

30. The sheet according to claim 3, wherein the thickness of the said porous layer of titanium oxide TiOₓ ranges between 20 and 500 nm.

31. The sheet according to claim 30, wherein the thickness of the said porous layer of TiOₓ ranges between 30 and 200 nm.

32. The sheet according to claim 3, wherein the voluminal porosity of the said porous layer of TiOₓ ranges between 20 and 40%.

33. The sheet according to claim 3, wherein the mean pore size of the said porous layer of TiOₓ ranges between 1 and 20 nm.

34. The sheet according to claim 3, wherein said porous layer of titanium oxide TiOₓ is a layer of titanium dioxide TiO₂.

35. The sheet according to claim 34, wherein the titanium dioxide TiO₂ is in its anatase crystalline form.

36. The sheet according to claim 3, wherein the thickness of the said barrier layer ranges between 20 and 850 nm.

37. The sheet according to claim 3, said barrier layer of metallic oxide or oxy-hydroxide is chosen from among the oxides or oxy-hydroxides of silicon, tin, aluminum, alone or in combination.

38. The sheet according to claim 38, wherein said barrier layer is chosen from among SiO₂, SnO₂, Al₂O₃, alone or in combination.

39. The sheet according to claim 3, wherein said barrier layer of metallic nitride or oxy-nitride NMₓ is a silicon nitride or oxy-nitride.
